(19) United States
(12) Patent Application Publication
(10) Pub. No.: US 2026/0109093 A1
(43) Pub. Date: Apr. 23, 2026

(54) METHOD OF MANUFACTURING MOLDED ARTICLE

(71) Applicant: CANON KABUSHIKI KAISHA, Tokyo (JP)

(72) Inventors: RYO SATO, Kanagawa (JP); DAIKI YAMAMOTO, Kanagawa (JP); YUKUO YAMAGUCHI, Tokyo (JP); SHIMPEI YOSHIKAWA, Kanagawa (JP); YASUAKI KITAYAMA, Kanagawa (JP)

(21) Appl. No.: 19/357,268

(22) Filed: Oct. 14, 2025

(30) Foreign Application Priority Data
Oct. 21, 2024 (JP) 2024-185176

(51) Int. Cl. B29C 45/16

(52) U.S. Cl. CPC B29C 45/1679; B29C 45/1635

(57) ABSTRACT

There is provided a technique that makes it possible to use a molded article provided with a gate on a front end side in a demolding direction of the molded article in a case of molding an integrally molded article by using a first molded article, a second molded article, and a third molded article. To this end, a movable mold is caused to move such that a first intermediate integrally molded article held by a fixed mold faces a third molded article held by a movable mold, and the integrally molded article is molded by joining the first intermediate integrally molded article to the third molded article with a molten resin.

### BACKGROUND

### Field of the Technology

The present disclosure relates to a method of manufacturing a molded article

### Description of the Related Art

A method of using a molten resin for joining molded articles to each other has been adopted in recent years in order to improve reliability and strength of joining in molded articles and to suppress costs on apparatuses. Specifically, multiple discrete components are molded with an injection molding machine. Thereafter, molds are opened once and the molds are moved to locate the discrete components so as to face each other. In this state, the molds are closed again so as to assemble the molded discrete components together and a molten resin is poured therein.

Japanese Patent Laid-Open No. 2021-88112 discloses a method of manufacturing an integrally molded article by laminating and joining three molded articles of a first molded article, a second molded article, and a third molded article in accordance with injection molding. In the joining of the molded articles according to Japanese Patent Laid-Open No. 2021-88112, there is disclosed a method of obtaining the integrally molded article by joining the third molded article to a joined article of the first molded article and the second molded article.

A demolding direction to extract a molded article from a mold after molding may be restricted depending on a shape of the molded article. Moreover, depending on the shape of the molded article, a gate position may be restricted in light of degasification, void suppression, and the like at the time of molding.

Meanwhile, depending on a shape of a primary molded article, there is a case where the demolding direction and an injecting direction are preferably the same, and there is also a case where the demolding direction and the injecting direction are preferably opposite.

For example, the demolding direction and the injecting direction of the primary molded article (the third molded article) to be joined at the end are the same in the case of Japanese Patent Laid-Open No. 2021-88112. Meanwhile, there is also a case where the demolding direction and the injecting direction of this primary molded article are preferably opposite. Particularly, such a situation may occur in a case where this primary molded article is larger in size or has a more complex shape as compared to another primary molded article. The method according to Japanese Patent Laid-Open No. 2021-88112 cannot deal with the case where someone wants to set the demolding direction and the injecting direction of the third molded article opposite to each other.

### SUMMARY

Given the circumstances, the present disclosure provides a technique for molding an integrally molded article by using a first molded article, a second molded article, and a third molded article, in which a molded article involving a demolding direction and an injecting direction being opposite directions can be used as the third molded article in a complex shape to be joined to a joined member obtained by joining the first molded article to the second molded article.

To this end, a manufacturing method of the present disclosure 1s a manufacturing method for manufacturing an integrally molded article including a first molded article, a second molded article, and a third molded article by using a fixed mold which is fixed and a movable mold which is movable, which includes a first molding step of causing the first molded article held by the fixed mold to face the second molded article held by the movable mold, closing the molds, and molding a first intermediate integrally molded article by joining the first molded article to the second molded article by pouring a molten resin into a space formed by the first molded article and the second molded article, and a second molding step of causing the first intermediate integrally molded article held by the fixed mold to face the third molded article held by the movable mold, closing the molds, and joining the first intermediate integrally molded article to the third molded article by pouring the molten resin into a space formed by the first intermediate integrally molded article and the third molded article.

According to the present disclosure, it is possible to provide a technique for molding an integrally molded article by using a first molded article, a second molded article, and a third molded article, in which a molded article involving a demolding direction and an injecting direction being opposite directions can be used as the third molded article in a complex shape to be joined to a joined member obtained by joining the first molded article to the second molded article.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing a common injection molding machine.

FIG. 2 is an exploded perspective view of a print head including an integrally molded article formed from three components.

FIG. 3 is a cross-sectional view showing a joined portion of a first intermediate integrally molded article.

FIG. 4 is a cross-sectional view showing a joined portion of an integrally molded article.

FIG. 5 is a diagram showing an aspect of joining respective molded articles to one another in accordance with a method of the related art.

FIG. 6 is a diagram showing an aspect of joining respective molded articles to one another in accordance with a method of the present disclosure.

FIG. 7A is a diagram showing a manufacturing process of an integrally molded article formed from three components, which is described in the order of steps.

FIG. 7B is another diagram showing the manufacturing process of the integrally molded article formed from three components, which is described in the order of steps.

FIG. 7C is still another diagram showing the manufacturing process of the integrally molded article formed from three components, which is described in the order of steps.

FIG. 8 is an exploded perspective view of a print head including an integrally molded article formed from four components.

FIG. 9 is a cross-sectional view showing a joined portion of a first intermediate integrally molded article.

FIG. 10 is a cross-sectional view showing a joined portion of a second intermediate integrally molded article.

FIG. 11 is a cross-sectional view showing a joined portion of an integrally molded article.

FIG. 12A is a diagram showing a manufacturing process of an integrally molded article formed from four components, which is described in the order of steps.

FIG. 12B is another diagram showing the manufacturing process of the integrally molded article formed from four components, which is described in the order of steps.

FIG. 12C is still another diagram showing the manufacturing process of the integrally molded article formed from four components, which is described in the order of steps.

FIG. 12D is yet another diagram showing the manufacturing process of the integrally molded article formed from four components, which is described in the order of steps.

### DESCRIPTION OF THE EMBODIMENTS

A first embodiment of the present disclosure will be described below with reference to the drawings.

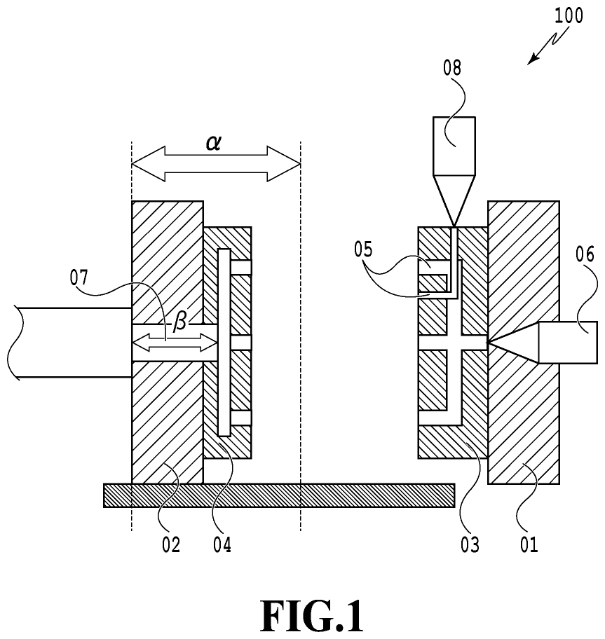

FIG. 1 is a diagram showing a common and conventional injection molding machine 100. The injection molding machine 100 includes a fixed platen 01 that is fixed and immovable, and a movable platen 02 that is movable in directions to open and close molds, which are provided in such a way as to face each other. The movable platen 02 is movable in a range of an arrow α in FIG. 1. A fixed mold 03 is mounted on the fixed platen 01, and the fixed platen 01 is provided with an injection unit 06 for injecting a resin. Meanwhile, a movable mold 04 is mounted on the movable platen 02. The fixed mold 03 may include manifolds 05 for distributing the resin, and may include an injection unit 08 configured to inject the resin. In the movable mold 04, a manifold 05 for molding a molded article and a manifold 05 for connecting the molded articles are preferably independent paths. It is a general practice to provide the fixed mold 03 with the injection unit 06 and the manifolds 05. The movable platen 02 includes an ejection mechanism 07 that is movable in directions of arrows β, and the ejection mechanism 07 can take out a molded article in the movable mold 04.

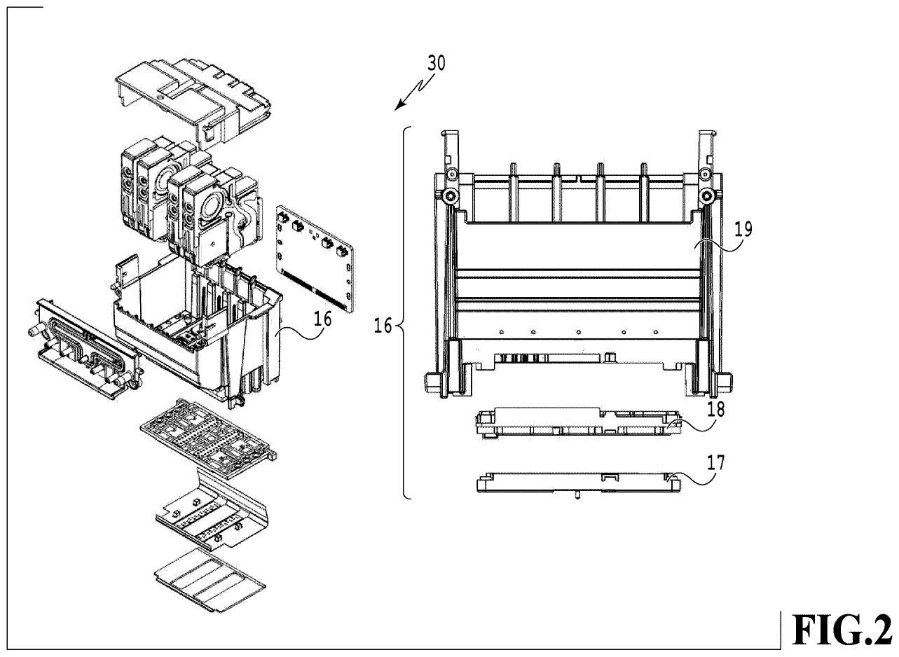

FIG. 2 is an exploded perspective view of a print head 30 including an integrally molded article 16 formed from three components. The integrally molded article 16 included in the print head 30 is formed by joining a first molded article 17, a second molded article 18, and a third molded article 19. The third molded article 19 has a complex shape on its side surface, and a slide mechanism (a sliding unit) slidably provided with a mold piece in a cavity of the mold is required in the case of molding.

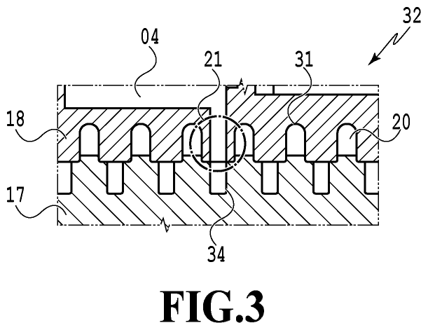

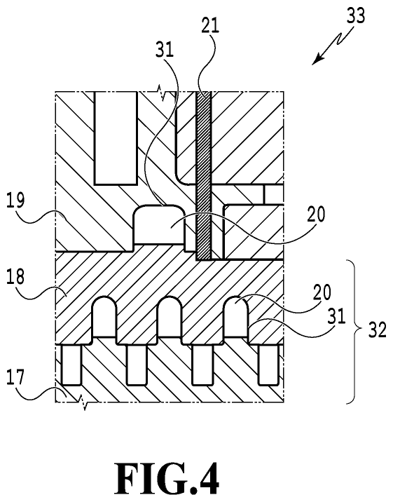

FIG. 3 is a cross-sectional view showing a joined portion of a first intermediate integrally molded article 32 obtained by joining the first molded article 17 to the second molded article 18 with a molten resin 20. FIG. 4 is a cross-sectional view showing a joined portion of an integrally molded article 33 obtained by joining the first intermediate integrally molded article 32 to the third molded article 19 with the molten resin 20.

Joining of the molded articles is carried out by pouring the molten resin 20 into a space portion 31 formed in a case where the molded articles are assembled together. In the case of pouring the molten resin 20 into the space portion 31, the vicinity of the space portion 31 where the molten resin 20 flows is backed up with a backup portion 21 of the mold so as not to succumb to a pressure of the molten resin 20. Particularly, in the case where a wall is thin, it is effective to perform the backup so as to suppress deformation of the wall. Meanwhile, as shown in FIG. 3, a flow channel 34 formed in the first molded article 17 is occluded by the backup portion 21, thereby preventing the molten resin 20 from flowing into the flow channel 34.

The thinner and longer the shape of the space portion 31 is, a pressure required to feed the molten resin 20 into the entire space portion 31 is increased more. In this case, a neighborhood of an abutting portion of the molded articles may be broadened by the pressure of the molten resin 20, and the molten resin 20 may flow to an intended portion. Accordingly, a location that would be broadened is backed up with the backup portion 21 as shown in FIGS. 3 and 4, thus suppressing the deformation of the molded articles and the flow of the molten resin 20 to the unintended portion.

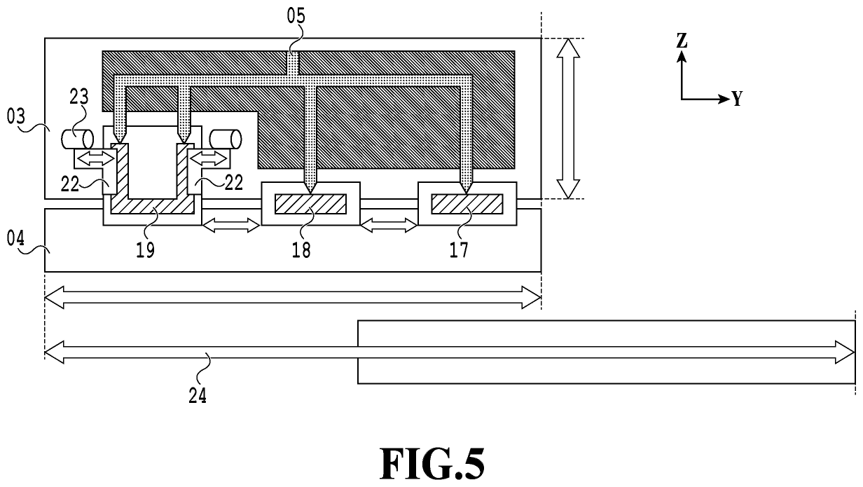

FIG. 5 is a diagram showing an aspect of joining respective molded articles to one another in accordance with the method of Japanese Patent Laid-Open No. 2021-88112 (the related art). In FIG. 5, y direction indicates a direction of movement of the movable mold 04 relative to the fixed mold 03, and an arrow 24 indicates the direction of movement of the movable mold 04. Z direction indicates a mold clamping direction of the fixed mold 03 and the movable mold 04. According to the method of Japanese Patent Laid-Open No. 2021-88112, a first intermediate integrally molded article obtained by joining the first molded article 17 to the second molded article 18 is left in the movable mold 04, and is caused to face the third molded article 19 having a complex contour in the fixed mold 03, and the first intermediate integrally molded article is joined to the third molded article 19.

In primary molding, the injection unit 06 (see FIG. 1) provided to the fixed mold 03 performs injection, thus molding the first molded article 17, the second molded article 18, and the third molded article 19. Each molded article is provided with a resin inlet called a gate. A portion to mold the third molded article 19 having the complex shape is provided with a slide 22, and the third molded article 19 after molding is surely left in the fixed mold 03 by being engaged with the slide 22. Meanwhile, in mold opening after the primary molding, the first molded article 17 is held by the movable mold 04 while the second molded article 18 is held by the fixed mold 03.

Thereafter, the movable mold 04 is caused to move in the y direction such that the first molded article 17 left in the movable mold 04 faces the second molded article 18 left in the fixed mold 03. Moreover, secondary molding of forming the first intermediate integrally molded article is carried out by clamping the movable mold 04 and the fixed mold 03 and joining the first molded article 17 to the second molded article 18 with the molten resin.

In mold opening after the secondary molding, the first intermediate integrally molded article is held by the movable mold 04. Thereafter, the movable mold 04 is caused to move in the y direction such that the first intermediate integrally molded article left in the movable mold 04 faces the third molded article 19 left in the fixed mold 03. Moreover, tertiary molding of forming the integrally molded article is carried out by clamping the movable mold 04 and the fixed mold 03 and joining the first intermediate integrally molded article to the third molded article 19 with the molten resin.

Regarding the third molded article 19, a direction to extract the molded article (hereinafter referred to as the demolding direction) from the fixed mold 03 after molding is restricted, and the third molded article 19 needs to be extracted in the-z direction. In the case of the method shown in FIG. 5, the third molded article 19 is provided with a gate at a rear end portion in the demolding direction (the-z direction).

Nonetheless, there is a case where is it preferable to provide the gate at a front end portion in the demolding direction (the-z direction) in light of degasification and void suppression depending on the shape of the molded article. However, in the example of FIG. 5, the demolding direction of the third molded article 19 is restricted. Therefore, it is not possible to provide the gate at the front end portion in the demolding direction (the-z direction).

Given the circumstances, the present embodiment will describe a manufacturing method that makes it possible to provide the gate at the front end portion in the demolding direction (the −z direction).

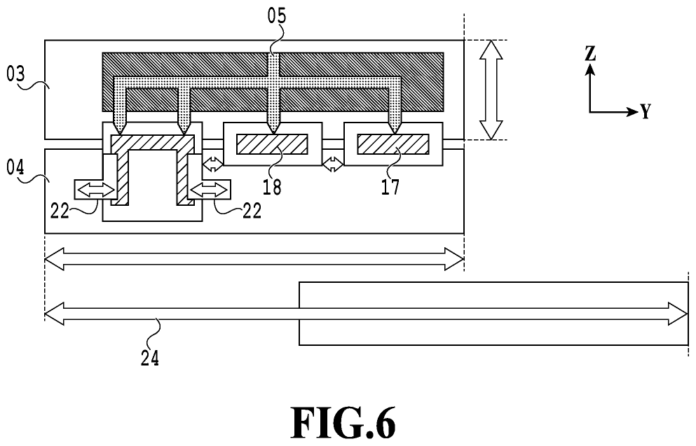

FIG. 6 is a diagram showing an aspect of joining the respective molded articles to one another according to the present embodiment. In the present embodiment, the movable mold 04 is caused to hold the third molded article 19 in the mold opening after the primary molding by providing the movable mold 04 with the slide 22. Meanwhile, in the mold opening after the secondary molding, the fixed mold 03 is configured to hold the first intermediate integrally molded article obtained by joining the first molded article 17 to the second molded article 18. Then, third molded article 19 in the movable mold 04 is caused to face the first intermediate integrally molded article held by the fixed mold 03, and the first intermediate integrally molded article 32 (see FIG. 3) is joined to the third molded article 19.

The third molded article 19 has the complex contour and the demolding direction thereof is restricted. There may be a case where the position to provide the gate is restricted in the molded article having the complex contour. Of the three molded articles, the molded article to be preferably provided with the gate on the front end side in the demolding direction should be defined as a third molded member to be joined at the end. In this way, the gate can be provided on the front end side in the demolding direction.

In primary molding, the injection unit 06 (see FIG. 1) provided to the fixed mold 03 performs injection, thus molding the first molded article 17, the second molded article 18, and the third molded article 19. Each molded article is provided with the resin inlet (a tail end portion of the manifold 05) called the gate. In the case of FIG. 6, the front and rear of each molded article are inverted as compared to the method of the related art shown in FIG. 5. Accordingly, the gate of each molded article is provided on the opposite side to that provided in each molded article molded in accordance with the method of the related art.

In the mold opening after the primary molding, the third molded article 19 is left in the movable mold 04. Meanwhile, the first molded article 17 is held by the fixed mold 03, and the second molded article 18 is held by the movable mold 04. Thereafter, the movable mold 04 is caused to move in the y direction such that the first molded article 17 left in the fixed mold 03 faces the second molded article 18 left in the movable mold 04. Moreover, secondary molding of forming the first intermediate integrally molded article is carried out by clamping the movable mold 04 and the fixed mold 03 and joining the first molded article 17 to the second molded article 18 with the molten resin.

In the mold opening after the secondary molding, the first intermediate integrally molded article is held by the fixed mold 03. Thereafter, the movable mold 04 is caused to move in the y direction such that the first intermediate integrally molded article left in the fixed mold 03 faces the third molded article 19 left in the movable mold 04. Moreover, tertiary molding of forming the integrally molded article is carried out by clamping the movable mold 04 and the fixed mold 03 and joining the first intermediate integrally molded article to the third molded article 19 with the molten resin.

In the present embodiment, the movable mold 04 is provided with the slide 22. Meanwhile, the movable mold 04 has the ejecting function in the case of the common injection molding machine, and no actuator is required as long as the slide 22 is activated by a drive force used for the ejecting function. Specifically, the ejecting function can perform a thrusting action in an opening-closing direction (the z direction), so that the slide 22 can be activated by providing a cam mechanism that interlocks with this thrusting action, for example, inside the movable mold 04.

Moreover, the movable mold 04 does not include a manifold for supplying the molten resin. Accordingly, even in the case where the movable mold 04 is increased in size in the opening-closing direction, such an increase does not affect the entire size of a combination of the fixed mold 03 and the movable mold 04. Since the movable mold 04 does not have a constraint on an internal space as compared to the fixed mold 03, a pitch between adjacent molded articles can be reduced in comparison with the case of providing the fixed mold 03 with the manifolds.

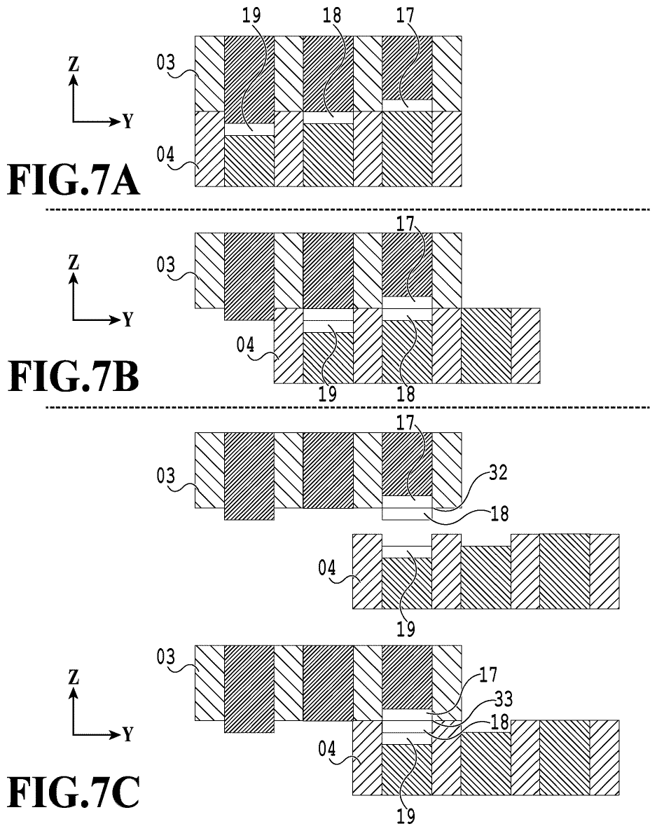

FIGS. 7A to 7C are diagrams showing a manufacturing process of the integrally molded article 16 formed from three components, which are described in the order of steps. In a first step shown in FIG. 7A, the first molded article 17, the second molded article 18, and the third molded article 19 are molded. Note that what is shown herein is one example and the first molded article 17, the second molded article 18, and the third molded article 19 may be molded at any timing as long as it is timing before joining the articles to one another.

In the state of mold opening subsequent to the first step, the first molded article 17 is in the state of being held by the fixed mold 03, the second molded article 18 is in the state of being held by the movable mold 04, and the third molded article 19 is in the state of being held by the movable mold 04. In this state, the movable mold 04 is caused to move such that the first molded article 17 faces the second molded article 18, and the molds are closed. Thus, the process proceeds to a second step as shown in FIG. 7B. In the second step, the molten resin 20 (see FIG. 3) is poured into the space portion 31 (see FIG. 3) formed by assembling the first molded article 17 and the second molded article 18 together, thereby joining the molded articles to each other so as to mold the first intermediate integrally molded article 32.

In the state of mold opening subsequent to the second step, the first intermediate integrally molded article 32 is in the state of being held by the fixed mold 03 and the third molded article 19 is in the state of being held by the movable mold 04. In this state, the movable mold 04 is caused to move such that the first intermediate integrally molded article 32 held by the fixed mold 03 faces the third molded article 19 held by the movable mold 04 as shown in an upper part of FIG. 7C, and the molds are closed as shown in a lower part of FIG. 7C. Then, the molten resin 20 (see FIG. 4) is poured into the space portion 31 (see FIG. 4) formed by assembling the first intermediate integrally molded article 32 and the third molded article 19 together, thereby joining the molded articles to each other so as to mold the integrally molded article 33 (a third step). After molding the integrally molded article 33, engagement between the slide unit and the third molded article 19 is released, and the integrally molded article 33 is taken out of the mold.

Here, the third molded article 19 may be molded in the second step. Molding timing for a molded article has an advantage and a disadvantage. As a time period between a point after molding and a point of carrying out integral molding is longer, the molded article can be cooled down more. Accordingly, the molded article is less likely to be deformed in the case where the molten resin is poured. For this reason, it is easy to prevent a leakage of the molten resin to an unintended portion. However, if the time period between the point after molding and the point of carrying out integral molding is long, there is a possibility of reduction in adhesion between the molded article and the molten resin. Accordingly, it is preferable to determine the molding timing for the molded article depending on a combination of materials, molding conditions, and the like.

In the meantime, the method of movement to the position where the molded articles face each other does not matter. In FIG. 6, the molded articles are caused to face each other by laterally moving the movable mold. Instead, the molded articles may be caused to face each other by rotationally moving the mold. Alternatively, the molded article may be grabbed with a robot arm or the like and may be moved to a position to face the other mold.

As described above, the movable mold 04 is caused to move such that the first intermediate integrally molded article 32 held by the fixed mold 03 faces the third molded article 19 held by the movable mold 04, and the integrally molded article is molded by joining the first intermediate integrally molded article 32 to the third molded article 19 with the molten resin 20. In this way, in the case of molding the integrally molded article by using the first molded article, the second molded article, and the third molded article, it is possible to provide the technique that makes it possible to use the molded article provided with the gate on the front end side in the demolding direction of the molded article.

### Second Embodiment

A second embodiment of the present disclosure will be described below with reference to the drawings. Note that the basic configuration of the present embodiment is the same as that of the first embodiment. Accordingly, characteristic configurations will be explained below. The present embodiment will describe a case of an integrally molded article formed from four components.

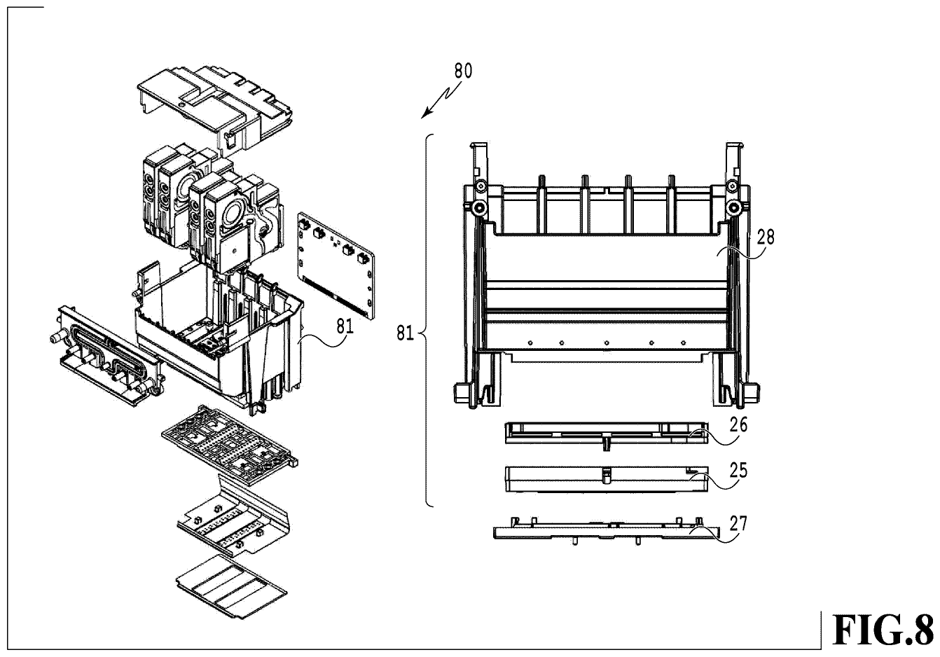

FIG. 8 is an exploded perspective view of a print head 80 including an integrally molded article 81 formed from four components. The integrally molded article 81 included in the print head 80 is formed by joining a fourth molded article 25, a fifth molded article 26, a sixth molded article 27, and a seventh molded article 28. The seventh molded article 28 has a complex shape on its side surface, and a mold requires a slide mechanism in the case of molding.

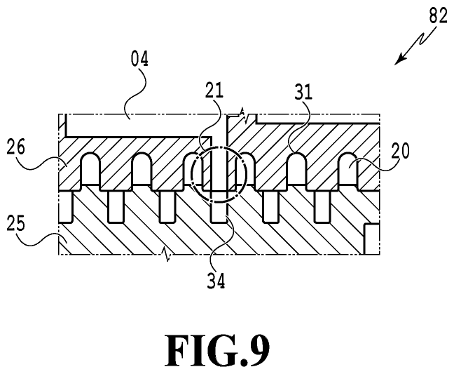

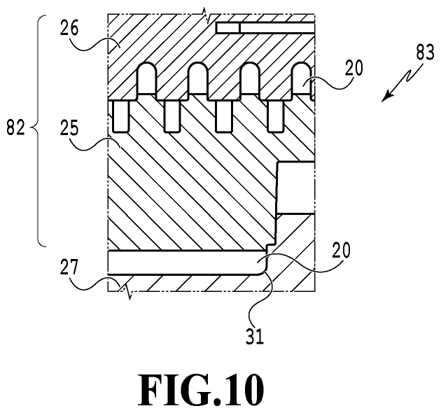

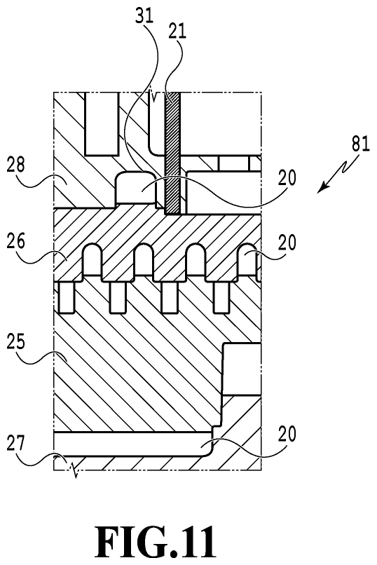

FIG. 9 is a cross-sectional view showing a joined portion of a first intermediate integrally molded article 82 obtained by joining the fourth molded article 25 to the fifth molded article 26 with the molten resin 20. FIG. 10 is a cross-sectional view showing a joined portion of a second intermediate integrally molded article 83 obtained by joining the first intermediate integrally molded article 82 to the sixth molded article 27 with the molten resin 20. FIG. 11 is a cross-sectional view showing a joined portion of the integrally molded article 81 obtained by joining the second intermediate integrally molded article 83 to the seventh molded article 28 with the molten resin 20.

Joining of the molded articles is carried out by pouring the molten resin 20 into the space portion 31 formed in the case where the molded articles are assembled together. In the case of pouring the molten resin 20 into the space portion 31, the vicinity of the space portion 31 where the molten resin 20 flows is backed up with the backup portion 21 of the mold so as not to succumb to a pressure of the molten resin 20. Particularly, in the case where a wall of the molded article is thin, it is effective to perform the backup so as to suppress deformation of the wall. Meanwhile, as shown in FIG. 9, the flow channel 34 formed in the fourth molded article 25 is occluded by the backup portion 21, thereby preventing the molten resin 20 from flowing into the flow channel 34.

The thinner and longer the shape of the space portion 31 is, the pressure required to feed the molten resin 20 into the entire space portion 31 is increased more. In this case, the neighborhood of the abutting portion of the molded articles may be broadened by the pressure of the molten resin 20, and the molten resin 20 may flow to an intended portion. Accordingly, a location that would be broadened is backed up with the backup portion 21 as shown in FIGS. 9 and 11, thus suppressing the deformation of the molded articles and the flow of the molten resin 20 to the unintended portion.

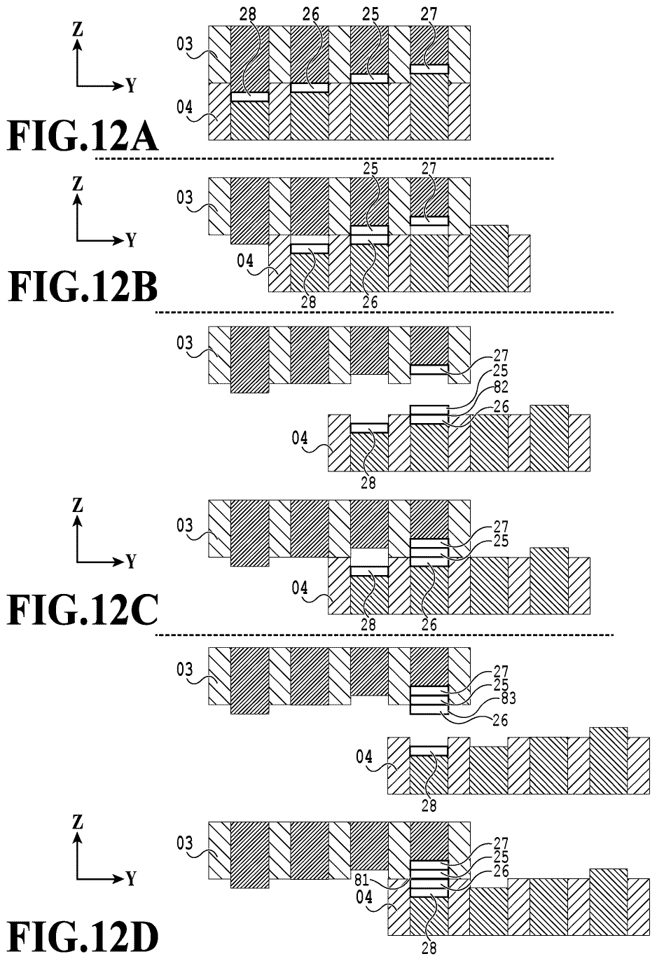

FIGS. 12A to 12D are diagrams showing a manufacturing process of the integrally molded article 81 formed from four components, which are described in the order of steps. In a first step shown in FIG. 12A, the fourth molded article 25, the fifth molded article 26, the sixth molded article 27, and the seventh molded article 28 are molded. Note that what is shown herein is one example and the fourth molded article 25, the fifth molded article 26, the sixth molded article 27, and the seventh molded article 28 may be molded at any timing as long as it is timing before molding the articles to one another.

In the state of mold opening subsequent to the first step, the fourth molded article 25 is in the state of being held by the fixed mold 03, the fifth molded article 26 is in the state of being held by the movable mold 04, the sixth molded article 27 is in the state of being held by the fixed mold 03, and the seventh molded article 28 is in the state of being held by the movable mold 04. In this state, the movable mold 04 is caused to move such that the fourth molded article 25 faces the fifth molded article 26, and the molds are closed. Thus, the process proceeds to a second step as shown in FIG. 12B. In the second step, the molten resin 20 (see FIG. 9) is poured into the space portion 31 (see FIG. 9) formed by assembling the fourth molded article 25 and the fifth molded article 26 together, thereby joining the molded articles to each other so as to mold the first intermediate integrally molded article 82.

In the state of mold opening subsequent to the second step, the first intermediate integrally molded article 82 is in the state of being held by the movable mold 04 and the sixth molded article 27 is in the state of being held by the fixed mold 03. In this state, the movable mold 04 is caused to move such that the first intermediate integrally molded article 82 held by the movable mold 04 faces the sixth molded article 27 held by the fixed mold 03 as shown in an upper part of FIG. 12C, and the molds are closed as shown in a lower part of FIG. 12C. Then, the molten resin 20 (see FIG. 10) is poured into the space portion 31 (see FIG. 10) formed by assembling the first intermediate integrally molded article 82 and the sixth molded article 27 together, thereby joining the molded articles to each other so as to mold the second intermediate integrally molded article 83 (a third step).

In the state of mold opening subsequent to the third step, the second intermediate integrally molded article 83 is in the state of being held by the fixed mold 03 and the seventh molded article 28 is in the state of being held by the movable mold 04. In this state, the movable mold 04 is caused to move such that the seventh molded article 28 held by the movable mold 04 faces the second intermediate integrally molded article 83 held by the fixed mold 03 as shown in an upper part of FIG. 12D, and the molds are closed as shown in a lower part of FIG. 12D. Then, the molten resin 20 (see FIG. 11) is poured into the space portion 31 (see FIG. 11) formed by assembling the second intermediate integrally molded article 83 and the seventh molded article 28 together, thereby joining the molded articles to each other so as to mold the integrally molded article 81 (a fourth step).

As described above, the present disclosure is also applicable to molding of the integrally molded article formed from the four components. Of the four components, the seventh molded article 28 having the most complex shape is formed by a resin flow supplied from the manifold 05 of the fixed mold 03 in the first step, and is then held by the movable mold 04 by using the slide 22 until the seventh molded article 28 is joined to the second intermediate integrally molded article 83 in the fourth step. Then, after molding the integrally molded article, the entire second intermediate integrally molded article can be taken out of the mold by using the slide 22 provided to the movable mold 04.

Note that the present disclosure may also be applied to molding of an integrally molded article formed from five or more components. In any case, of the multiple components formed in the first step, the component having the most complex shape may be held by the movable mold. Then, in a final step of finishing the integrally molded article, the relevant component may be joined to another intermediate integrally molded article, and the entire molded articles formed into the integrally molded article may be taken out of the mold by using the slide 22 provided to the movable mold.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No.2024-185176, filed Oct. 21, 2024, which is hereby incorporated by reference herein in its entirety.

What is claimed is:

1. A method of manufacturing a molded article for manufacturing an integrally molded article including a first molded article, a second molded article, and a third molded article by using a fixed mold which is fixed and a movable mold which is movable, the method comprising:
a first molding step of causing the first molded article held by the fixed mold to face the second molded article held by the movable mold, closing the molds, and molding a first intermediate integrally molded article by joining the first molded article to the second molded article by pouring a molten resin into a space formed by the first molded article and the second molded article; and
a second molding step of causing the first intermediate integrally molded article held by the fixed mold to face the third molded article held by the movable mold, closing the molds, and joining the first intermediate integrally molded article to the third molded article by pouring the molten resin into a space formed by the first intermediate integrally molded article and the third molded article.

2. The method of manufacturing a molded article according to claim 1, further comprising:
a molding article molding step of closing the fixed mold and the movable mold, and molding the first molded article, the second molded article, and the third molded article.

3. The method of manufacturing a molded article according to claim 2, wherein the molten resin is injected in the first molding step and the second molding step from an injection unit provided to the fixed mold.

4. The method of manufacturing a molded article according to claim 3, wherein
the injection unit provided to the fixed mold includes a first injection unit and a second injection unit,
the molten resin is injected from the first injection unit in the molding article molding step, and
the molten resin is injected from the second injection unit in the first molding step and the second molding step.

5. The method of manufacturing a molded article according to claim 1, wherein the movable mold is caused to move in a sliding manner in order to cause the first molded article to face the second molded article.

6. The method of manufacturing a molded article according to claim 1, wherein movement of the movable mold is rotational movement within a plane opposed to the fixed mold.

7. The method of manufacturing a molded article according to claim 1, wherein a robot arm is used in order to cause the first molded article to face the second molded article.

8. The method of manufacturing a molded article according to claim 3, wherein the molten resin injected from the injection unit is distributed by a manifold provided to the fixed mold.

9. The method of manufacturing a molded article according to claim 1, wherein a slidable sliding unit provided to the movable mold is caused to slide after the second molding step, and engagement between the sliding unit and the third molded article is released.

10. The method of manufacturing a molded article according to claim 9, wherein the third molded article formed in the first molding step is held by the movable mold by being engaged with the sliding unit in a case of opening the fixed mold and the movable mold.

11. The method of manufacturing a molded article according to claim 1, wherein backup is carried out by the mold in the first molding step and the second molding step in order to suppress deformation of the molded article.

12. A method of manufacturing a molded article for manufacturing an integrally molded article including a first molded article, a second molded article, a third molded article, and a fourth molded article by using a fixed mold which is fixed and a movable mold which is movable, the method comprising:
a first molding step of causing the first molded article held by the fixed mold to face the second molded article held by the movable mold, closing the molds, and molding a first intermediate integrally molded article by joining the first molded article to the second molded article by pouring a molten resin into a space formed by the first molded article and the second molded article;
a second molding step of causing the first intermediate integrally molded article held by the movable mold to face the third molded article held by the fixed mold, closing the molds, and molding a second intermediate integrally molded article by joining the first intermediate integrally molded article to the third molded article by pouring the molten resin into a space formed by the first intermediate integrally molded article and the third molded article; and
a third molding step of causing the second intermediate integrally molded article held by the fixed mold to face the fourth molded article held by the movable mold, closing the molds, and joining the second intermediate integrally molded article to the fourth molded article by pouring the molten resin into a space formed by the second intermediate integrally molded article and the fourth molded article.

13. A method of manufacturing a molded article for manufacturing an integrally molded article by using a first molded article, a second molded article, and a third molded article and by using a fixed mold which is fixed and a movable mold which is movable, the method comprising:
a first molding step of causing the first molded article to face the second molded article, closing the molds, and molding a first intermediate integrally molded article by joining the first molded article to the second molded article by pouring a molten resin into a space formed by the first molded article and the second molded article; and
a second molding step of causing the first intermediate integrally molded article held by the fixed mold to face the third molded article held by the movable mold, closing the molds, and joining the first intermediate integrally molded article to the third molded article by pouring the molten resin into a space formed by the first intermediate integrally molded article and the third molded article, wherein
the molten resin is injected in the first molding step and the second molding step from an injection unit provided to the fixed mold.
